(19) United States
(12) Patent Application Publication
(10) Pub. No.: US 2024/0005508 A1
(43) Pub. Date: Jan. 4, 2024

(54) SYSTEMS AND METHODS FOR IMAGE SEGMENTATION

(71) Applicant: SHANGHAI UNITED IMAGING HEALTHCARE CO., LTD., Shanghai (CN)

(72) Inventor: Wei ZHANG, Shanghai (CN)

(73) Assignee: SHANGHAI UNITED IMAGING HEALTHCARE CO., LTD., Shanghai (CN)

(21) Appl. No.: 18/468,098

(22) Filed: Sep. 15, 2023

Related U.S. Application Data
(63) Continuation of application No. PCT/CN2021/080822, filed on Mar. 15, 2021.

(51) Int. Cl. G06T 7/10; G06V 10/25

(52) U.S. Cl. CPC G06T 7/10; G06V 10/25; G06T 2207/10072; G06T 2207/20081; G06T 2207/20084

(57) ABSTRACT

Systems and methods for image segmentation are provided. A system may obtain a first image of a subject. The system may obtain non-image information associated with at least one of the first image or the subject. The system may further determine a region of interest (ROI) of the first image based on the first image, the non-image information, and an image segmentation model.

### CROSS-REFERENCE TO RELATED APPLICATIONS

This application is a Continuation of International Application No. PCT/CN2021/080822, filed on Mar. 15, 2021, the entire contents of which are incorporated herein by reference.

### TECHNICAL FIELD

The disclosure generally relates to image segmentation, and more particularly relates to systems and methods for image segmentation based on machine learning.

### BACKGROUND

Image segmentation has been widely used in medical fields. Segmenting medical images (e.g., CT images, MRI images, PET images, etc.) to obtain regions of interest (ROIs), such as an organ, a tumor, may help doctors to diagnose and treat disease. If an image segmentation method uses only imaging information, the accuracy of the segmentation results may be low. Therefore, it is desired to provide efficient and accurate systems and methods for image segmentation using not only the imaging information but also non-image information of the images.

### SUMMARY

In an aspect of the present disclosure, a system for image segmentation is provided. The system may include at least one storage device including a set of instructions, and at least one processor configured to communicate with the at least one storage device. When executing the set of instructions, the system may be configured to direct the system to perform the following operations. The system may obtain a first image of a subject. The system may obtain non-image information associated with at least one of the first image or the subject. The system may further determine a region of interest (ROI) of the first image based on the first image, the non-image information, and an image segmentation model.

In some embodiments, the image segmentation model may include a first model configured to transform the non-image information into a second image.

In some embodiments, the determining the ROI of the first image may include determining a vector based on the non-image information and determining the second image by inputting the vector into the first model.

In some embodiments, the image segmentation model may further include a second model configured to segment the first image based on the second image.

In some embodiments, the second model may include a multichannel neural network.

In some embodiments, the non-image information may include at least one of: information relating to a user associated with the first image or the subject, biological information of the subject, or image acquisition information of the first image.

In some embodiments, the image segmentation model may be obtained by a training process. The training process may include obtaining a plurality of training samples each of which includes a first sample image of a sample subject, sample non-image information associated with the first sample image and the sample subject, and a target ROI of the first sample image. The training process may further include generating the image segmentation model by training a preliminary image segmentation model using the plurality of training samples.

In some embodiments, the preliminary image segmentation model may include a first preliminary model configured to transform the sample non-image information of a sample subject into a second sample image.

In some embodiments, the preliminary image segmentation model may further include a second preliminary model configured to segment the first sample image of a sample subject.

In some embodiments, the generating the image segmentation model may include determining the first model by training the first preliminary model using the sample non-image information of the plurality of training samples; and determining, based on the first model, the second model by training the second preliminary model using the first sample images and the target ROIs of the first sample images of the plurality of training samples.

In some embodiments, the generating the image segmentation model may include determining the first model and the second model simultaneously based on the first preliminary model, the second preliminary model, and the plurality of training samples.

In some embodiments, the generating the image segmentation model may further include assessing a loss function that relates to the first model and the second model.

In some embodiments, the generating the image segmentation model may further include assessing a first loss function that relates to the first model.

In some embodiments, the generating the image segmentation model may further include assessing a second loss function that relates to the second model.

In another aspect of the present disclosure, a method for image segmentation is provided. The method may be implemented on at least one computing device, each of which may include at least one processor and a storage device. The method may include obtaining a first image of a subject. The method may include obtaining non-image information associated with at least one of the first image or the subject. The method may further include determining a region of interest (ROI) of the first image based on the first image, the non-image information, and an image segmentation model.

In still another aspect of the present disclosure, a non-transitory computer-readable medium storing at least one set of instructions is provided. When executed by at least one processor, the at least one set of instructions may direct the at least one processor to perform a method. The method may include obtaining a first image of a subject. The method may include obtaining non-image information associated with at least one of the first image or the subject. The method may further include determining a region of interest (ROI) of the first image based on the first image, the non-image information, and an image segmentation model.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary imaging system according to some embodiments of the present disclosure;

FIG. 2 is a schematic diagram illustrating hardware and/or software components of an exemplary computing device according to some embodiments of the present disclosure;

FIG. 3 is a schematic diagram illustrating hardware and/or software components of an exemplary mobile device according to some embodiments of the present disclosure;

FIG. 4A is a block diagram illustrating an exemplary processing device according to some embodiments of the present disclosure;

FIG. 4B is a block diagram illustrating an exemplary processing device according to some embodiments of the present disclosure;

FIG. 5 is a flowchart illustrating an exemplary process for image segmentation according to some embodiments of the present disclosure;

FIG. 6 is a flowchart illustrating an exemplary process for generating an image segmentation model according to some embodiments of the present disclosure;

FIG. 7 is a flowchart illustrating an exemplary process for determining a first model and a second model of an image segmentation model according to some embodiments of the present disclosure;

FIG. 8 is a flowchart illustrating an exemplary process for determining a first model and a second model of an image segmentation model according to some embodiments of the present disclosure;

FIG. 9 is a schematic diagram illustrating an exemplary training process for training an image segmentation model according to some embodiments of the present disclosure; and

FIG. 10 is a schematic diagram illustrating an exemplary process of an application of an image segmentation model according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, sections, or assembly of different levels in ascending order. However, the terms may be displaced by another expression if they achieve the same purpose.

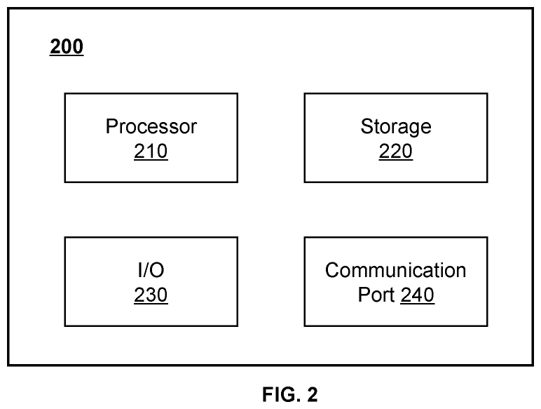

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices (e.g., processor 210 as illustrated in FIG. 2) may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that the term “system,” “engine,” “unit,” “module,” and/or “block” used herein are one method to distinguish different components, elements, parts, sections, or assembly of different levels in ascending order. However, the terms may be displaced by another expression if they achieve the same purpose.

It will be understood that when a unit, engine, module, or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items. The term “image” in the present disclosure is used to collectively refer to image data (e.g., scan data) and/or images of various forms, including a two-dimensional (2D) image, a three-dimensional (3D) image, a four-dimensional (4D) image, etc.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in an inverted order, or simultaneously. Moreover, one or more other operations may be added to the flowcharts. One or more operations may be removed from the flowcharts.

Provided herein are systems and methods for non-invasive biomedical imaging and/or treatment, such as for disease diagnostic, treatment, or research purposes. In some embodiments, the systems may include a radiotherapy (RT) system, a computed tomography (CT) system, an emission computed tomography (ECT) system, an X-ray photography (XR) system, a positron emission tomography (PET) system, a magnetic resonance (MR) system, of the like, or any combination thereof. It should be noted that the imaging system described below is merely provided for illustration purposes, and not intended to limit the scope of the present disclosure.

An aspect of the present disclosure relates to systems and methods for determining a region of interest (ROI) of a subject by image segmentation. The systems and methods may segment, based on a machine learning algorithm, an image of the subject using not only imaging information but also non-image information of the image and/or the subject. To this end, the systems and methods may apply an image segmentation model to the image and the non-image information. In some embodiments, the image segmentation model may be a single model to process the image and the non-image information. In some embodiments, the image segmentation model may include a first model and a second model. The first model may be configured to process the non-image information. For example, the first model may convert the non-image information into an image representing the non-image information. The image to be segmented and the image obtained from the first model may be input into the second model to determine the ROI of the image. By taking non-image information associated with an image and/or the subject into consideration for image segmentation, the accuracy of the segmentation result may be improved. Moreover, by employing the image segmentation model, the image segmentation may be automated, thereby reducing user time and/or cross-user variations in image segmentation.

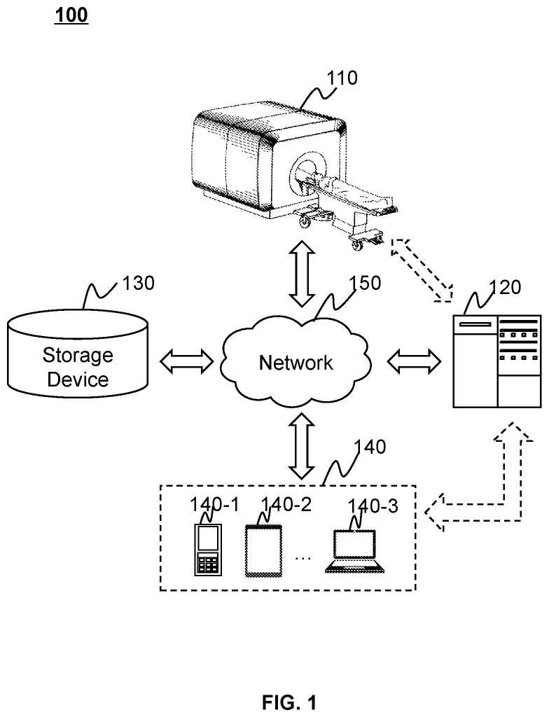

FIG. 1 is a schematic diagram illustrating an exemplary imaging system 100 according to some embodiments of the present disclosure. In some embodiments, the imaging system 100 may include modules and/or components for performing imaging and/or related analysis.

Merely by way of example, as illustrated in FIG. 1, the imaging system 100 may include an imaging device 110, a processing device 120, a storage device 130, one or more terminals 140, and a network 150. The components in the imaging system 100 may be connected in various ways. Merely by way of example, the imaging device 110 may be connected to the processing device 120 through the network 150 or directly as illustrated in FIG. 1. As another example, the terminal(s) 140 may be connected to the processing device 120 via the network 150 or directly as illustrated in FIG. 1.

In some embodiments, the imaging device 110 may be configured to obtain one or more images relating to a subject. The image relating to a subject may include an image, image data (e.g., projection data, scan data, etc.), or a combination thereof. In some embodiments, the image may include a two-dimensional (2D) image, a three-dimensional (3D) image, a four-dimensional (4D) image, or the like, or any combination thereof. The subject may be biological or non-biological. For example, the subject may include a patient, a man-made object, etc. As another example, the subject may include a specific portion, organ, and/or tissue of the patient. For example, the subject may include the head, the neck, the thorax, the heart, the stomach, a blood vessel, soft tissue, a tumor, nodules, or the like, or any combination thereof.

In some embodiments, the imaging device 110 may be a medical imaging device. For example, the imaging device may include, a magnetic resonance imaging (MRI) device, a computed tomography (CT) device, a positron emission tomography (PET) device, a single photon emission computed tomography (SPECT) device, an ultrasound device, an X-ray device, a computed tomography-magnetic resonance imaging (MRI-CT) device, a positron emission tomography-magnetic resonance imaging (PET-MRI) device, a single photon emission computed tomography-magnetic resonance imaging (SPECT-MRI) device, a digital subtraction angiography-magnetic resonance imaging (DSA-MRI) device, a positron emission tomography-computed tomography (PET-CT) device, a single photon emission computed tomography-computed tomography (SPECT-CT) device, or the like, or any combination thereof. It should be noted that the imaging device 110 shown in FIG. 1 is merely provided for illustration, and not intended to limit the scope of the present disclosure. The imaging device 110 may be any imaging device that is capable to obtain images of the subject.

The processing device 120 may process data and/or information obtained from the imaging device 110, the terminal(s) 140, and/or the storage device 130. For example, the processing device 120 may obtain a first image of a subject from the imaging device 110. The processing device 120 may also obtain non-image information associated with the first image and/or the subject from the imaging device 110, the terminal(s) 140, and/or the storage device 130. The processing device 120 may further determine a region of interest (ROI) of the first image based on the first image, the non-image information, and an image segmentation model. As another example, the processing device 120 may generate the image segmentation model by training a preliminary image segmentation model using a plurality of training samples.

In some embodiments, the generation and/or updating of the image segmentation model may be performed on a processing device, while the application of the image segmentation model may be performed on a different processing device. In some embodiments, the generation of the image segmentation model may be performed on a processing device of a system different from the imaging system 100 or a server different from a server including the processing device 120 on which the application of the image segmentation model is performed. For instance, the generation of the image segmentation model may be performed on a first system of a vendor who provides and/or maintains such an image segmentation model and/or has access to training samples used to generate the image segmentation model, while image segmentation based on the provided image segmentation model may be performed on a second system of a client of the vendor. In some embodiments, the generation of the image segmentation model may be performed online in response to a request for image segmentation. In some embodiments, the generation of the image segmentation model may be performed offline.

In some embodiments, the image segmentation model may be generated and/or updated (or maintained) by, e.g., the manufacturer of the imaging device 110 or a vendor. For instance, the manufacturer or the vendor may load the image segmentation model into the imaging system 100 or a portion thereof (e.g., the processing device 120) before or during the installation of the imaging device 110 and/or the processing device 120, and maintain or update the image segmentation model from time to time (periodically or not). The maintenance or update may be achieved by installing a program stored on a storage device (e.g., a compact disc, a USB drive, etc.) or retrieved from an external source (e.g., a server maintained by the manufacturer or vendor) via the network 150. The program may include a new model (e.g., a new image segmentation model) or a portion of a model that substitutes or supplements a corresponding portion of the model.

In some embodiments, the processing device 120 may be a computer, a user console, a single server or a server group, etc. The server group may be centralized or distributed. In some embodiments, the processing device 120 may be local or remote. For example, the processing device 120 may access information and/or data stored in the imaging device 110, the terminal(s) 140, and/or the storage device 130 via the network 150. As another example, the processing device 120 may be directly connected to the imaging device 110, the terminal(s) 140, and/or the storage device 130 to access stored information and/or data. In some embodiments, the processing device 120 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

The storage device 130 may store data, instructions, and/or any other information. In some embodiments, the storage device 130 may store data obtained from the terminal(s) 140 and/or the processing device 120. For example, the storage device 130 may store the image and/or image data acquired by the imaging device 110. As another example, the storage device 130 may store non-image information associated with the image or image data acquired from the imaging device 110 and/or the terminal(s) 140. As still another example, the storage device 130 may store one or more algorithms for segmenting the image (e.g., an image segmentation model, etc.). In some embodiments, the storage device 130 may store data and/or instructions that the processing device 120 may execute or use to perform exemplary methods/systems described in the present disclosure. In some embodiments, the storage device 130 may include a mass storage device, a removable storage device, a volatile read-and-write memory, a read-only memory (ROM), or the like, or any combination thereof. Exemplary mass storage devices may include a magnetic disk, an optical disk, a solid-state drive, etc. Exemplary removable storage devices may include a flash drive, a floppy disk, an optical disk, a memory card, a zip disk, a magnetic tape, etc.

Exemplary volatile read-and-write memories may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 130 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 130 may be connected to the network 150 to communicate with one or more other components in the imaging system 100 (e.g., the processing device 120, the terminal(s) 140, etc.). One or more components in the imaging system 100 may access the data or instructions stored in the storage device 130 via the network 150. In some embodiments, the storage device 130 may be directly connected to or communicate with one or more other components in the imaging system 100 (e.g., the processing device 120, the terminal(s) 140, etc.). In some embodiments, the storage device 130 may be part of the processing device 120.

The terminal(s) 140 may include a mobile device 140-1, a tablet computer 140-2, a laptop computer 140-3, or the like, or any combination thereof. In some embodiments, the mobile device 140-1 may include a smart home device, a wearable device, a mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a bracelet, a footgear, eyeglasses, a helmet, a watch, clothing, a backpack, a smart accessory, or the like, or any combination thereof. In some embodiments, the mobile device may include a mobile phone, a personal digital assistant (PDA), a gaming device, a navigation device, a point of sale (POS) device, a laptop, a tablet computer, a desktop, or the like, or any combination thereof. In some embodiments, the virtual reality device and/or the augmented reality device may include a virtual reality helmet, virtual reality glasses, a virtual reality patch, an augmented reality helmet, augmented reality glasses, an augmented reality patch, or the like, or any combination thereof. For example, the virtual reality device and/or the augmented reality device may include a Google Glass™, an Oculus Rift™, a Hololens™, a Gear VR™, etc. In some embodiments, the terminal(s) 140 may be part of the processing device 120.

The network 150 may include any suitable network that can facilitate the exchange of information and/or data for the imaging system 100. In some embodiments, one or more components of the imaging device 110 (e.g., a CT device, a PET device, etc.), the terminal(s) 140, the processing device 120, the storage device 130, etc., may communicate information and/or data with one or more other components of the imaging system 100 via the network 150. For example, the processing device 120 may obtain an image from the imaging device 110 via the network 150. As another example, the processing device 120 may obtain user instructions from the terminal(s) 140 via the network 150. The network 150 may be and/or include a public network (e.g., the Internet), a private network (e.g., a local area network (LAN), a wide area network (WAN)), etc.), a wired network (e.g., an Ethernet network), a wireless network (e.g., an 802.11 network, a Wi-Fi network, etc.), a cellular network (e.g., a Long Term Evolution (LTE) network), a frame relay network, a virtual private network (“VPN”), a satellite network, a telephone network, routers, hubs, switches, server computers, and/or any combination thereof. Merely by way of example, the network 150 may include a cable network, a wireline network, a fiber-optic network, a telecommunications network, an intranet, a wireless local area network (WLAN), a metropolitan area network (MAN), a public telephone switched network (PSTN), a Bluetooth™ network, a ZigBee™ network, a near field communication (NFC) network, or the like, or any combination thereof. In some embodiments, the network 150 may include one or more network access points. For example, the network 150 may include wired and/or wireless network access points such as base stations and/or internet exchange points through which one or more components of the imaging system 100 may be connected to the network 150 to exchange data and/or information.

It should be noted that the above description of the imaging system 100 is merely provided for the purposes of illustration, and not intended to limit the scope of the present disclosure. For persons having ordinary skills in the art, multiple variations and modifications may be made under the teachings of the present disclosure. For example, the imaging system 100 may include one or more additional components and/or one or more components of the imaging system 100 described above may be omitted. Additionally or alternatively, two or more components of the imaging system 100 may be integrated into a single component. A component of the imaging system 100 may be implemented on two or more sub-components.

FIG. 2 is a schematic diagram illustrating hardware and/or software components of an exemplary computing device 200 may be implemented according to some embodiments of the present disclosure. The computing device 200 may be used to implement any component of the imaging system as described herein. For example, the processing device 120 and/or a terminal 140 may be implemented on the computing device 200, respectively, via its hardware, software program, firmware, or a combination thereof. Although only one such computing device is shown, for convenience, the computer functions relating to the imaging system 100 as described herein may be implemented in a distributed fashion on a number of similar platforms, to distribute the processing load. As illustrated in FIG. 2, the computing device 200 may include a processor 210, a storage 220, an input/output (I/O) 230, and a communication port 240.

The processor 210 may execute computer instructions (program codes) and perform functions of the processing device 120 in accordance with techniques described herein. The computer instructions may include, for example, routines, programs, objects, components, signals, data structures, procedures, modules, and functions, which perform particular functions described herein. For example, the processor 210 may perform image segmentation on an image of a subject to determine a region of interest (ROI) of the image based on the image, non-image information associated with the image and/or the subject, and an image segmentation model. As another example, the processor 210 may generate an image segmentation model. In some embodiments, the processor 210 may perform instructions obtained from the terminal(s) 140. In some embodiments, the processor 210 may include one or more hardware processors, such as a microcontroller, a microprocessor, a reduced instruction set computer (RISC), an application-specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field-programmable gate array (FPGA), an advanced RISC machine (ARM), a programmable logic device (PLD), any circuit or processor capable of executing one or more functions, or the like, or any combinations thereof.

Merely for illustration, only one processor is described in the computing device 200. However, it should be noted that the computing device 200 in the present disclosure may also include multiple processors. Thus operations and/or method steps that are performed by one processor as described in the present disclosure may also be jointly or separately performed by the multiple processors. For example, if in the present disclosure the processor of the computing device 200 executes both operation A and operation B, it should be understood that operation A and operation B may also be performed by two or more different processors jointly or separately in the computing device 200 (e.g., a first processor executes operation A and a second processor executes operation B, or the first and second processors jointly execute operations A and B).

The storage 220 may store data/information obtained from the imaging device 110, the terminal(s) 140, the storage device 130, or any other component of the imaging system 100. In some embodiments, the storage 220 may include a mass storage device, a removable storage device, a volatile read-and-write memory, a read-only memory (ROM), or the like, or any combination thereof. In some embodiments, the storage 220 may store one or more programs and/or instructions to perform exemplary methods described in the present disclosure. For example, the storage 220 may store a program for the processing device 120 for performing image segmentation on an image of a subject.

The I/O 230 may input or output signals, data, and/or information. In some embodiments, the I/O 230 may enable user interaction with the processing device 120. In some embodiments, the I/O 230 may include an input device and an output device. Exemplary input devices may include a keyboard, a mouse, a touch screen, a microphone, or the like, or a combination thereof. Exemplary output devices may include a display device, a loudspeaker, a printer, a projector, or the like, or a combination thereof. Exemplary display devices may include a liquid crystal display (LCD), a light-emitting diode (LED)-based display, a flat panel display, a curved screen, a television device, a cathode ray tube (CRT), or the like, or a combination thereof.

The communication port 240 may be connected with a network (e.g., the network 150) to facilitate data communications. The communication port 240 may establish connections between the processing device 120 and the imaging device 110, the terminal(s) 140, or the storage device 130. The connection may be a wired connection, a wireless connection, or a combination of both that enables data transmission and reception. The wired connection may include an electrical cable, an optical cable, a telephone wire, or the like, or any combination thereof. The wireless connection may include a Bluetooth network, a Wi-Fi network, a WiMax network, a WLAN, a ZigBee network, a mobile network (e.g., 3G, 4G, 5G, etc.), or the like, or any combination thereof. In some embodiments, the communication port 240 may be a standardized communication port, such as RS232, RS485, etc. In some embodiments, the communication port 240 may be a specially designed communication port. For example, the communication port 240 may be designed in accordance with the digital imaging and communications in medicine (DICOM) protocol.

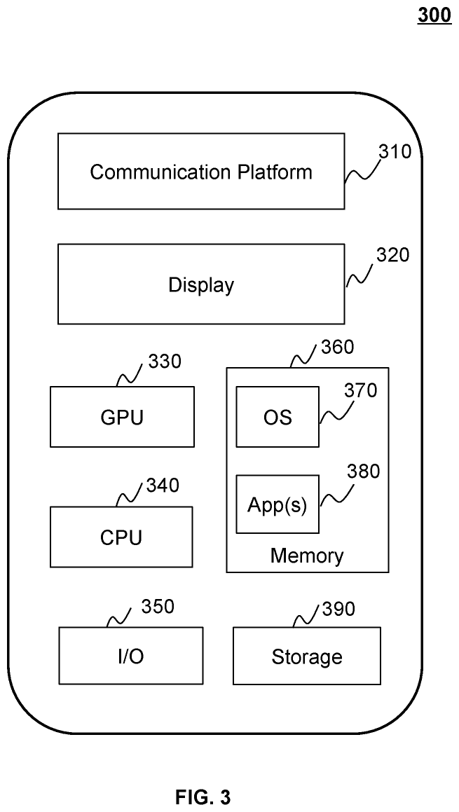

FIG. 3 is a schematic diagram illustrating hardware and/or software components of an exemplary mobile device 300 according to some embodiments of the present disclosure. In some embodiments, one or more components (e.g., a terminal 140 and/or the processing device 120) of the imaging system 100 may be implemented on the mobile device 300.

As illustrated in FIG. 3, the mobile device 300 may include a communication platform 310, a display 320, a graphics processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS, Android, Windows Phone, etc.) and one or more applications 380 may be loaded into the memory 360 from the storage 390 in order to be executed by the CPU 340. The applications 380 may include a browser or any other suitable mobile apps for receiving and rendering information relating to image processing or other information from the processing device 120. User interactions with the information stream may be achieved via the I/O 350 and provided to the processing device 120 and/or other components of the imaging system 100 via the network 150.

To implement various modules, units, and their functionalities described in the present disclosure, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to generate an image as described herein. A computer with user interface elements may be used to implement a personal computer (PC) or another type of work station or terminal device, although a computer may also act as a server if appropriately programmed. It is believed that those skilled in the art are familiar with the structure, programming, and general operation of such computer equipment and as a result, the drawings should be self-explanatory.

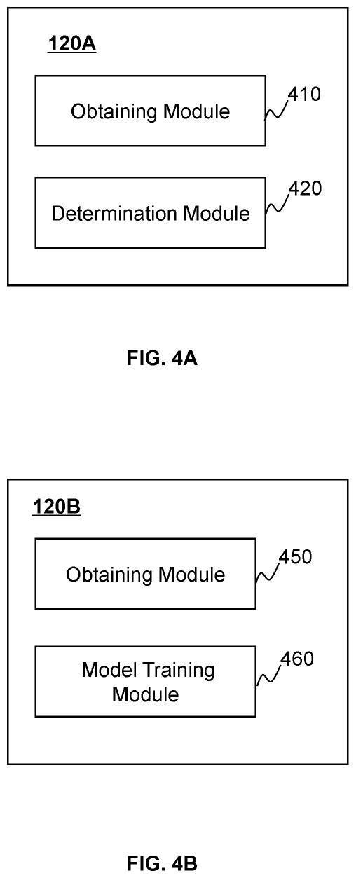

FIG. 4A and FIG. 4B are block diagrams illustrating exemplary processing devices 120A and 120B according to some embodiments of the present disclosure. In some embodiments, the processing devices 120A and 120B may be embodiments of the processing device 120 as described in connection with FIG. 1. In some embodiments, the processing devices 120A and 120B may be respectively implemented on a processing unit (e.g., the processor 210 illustrated in FIG. 2 or the CPU 340 as illustrated in FIG. 3). Merely by way of example, the processing devices 120A may be implemented on a CPU 340 of a terminal device, and the processing device 120B may be implemented on a computing device 200. Alternatively, the processing devices 120A and 120B may be implemented on a same computing device 200 or a same CPU 340. For example, the processing devices 120A and 120B may be implemented on a same computing device 200.

As illustrated in FIG. 4A, the processing device 120A may include an obtaining module 410 and a determination module 420.

The obtaining module 410 may be configured to obtain a first image (e.g., a medical image) of a subject. For example, the obtaining module 410 may obtain the first image of the subject by scanning the subject using an imaging device (e.g., the imaging device 110 of the imaging system 100). As another example, the obtaining module 410 may process original image data (or an original image determined based on the original image data) of the subject obtained from the imaging device 110 to obtain the first image.

The obtaining module 410 may be further configured to obtain non-image information associated with the first image and/or the subject. For example, the obtaining module 410 may obtain the non-image information associated with the first image and/or the subject input by a user of the imaging system 100. As another example, at least a portion of the non-image information associated with the first image and/or the subject may be previously stored in a storage device (e.g., the storage device 130, the storage 220, etc.), and the obtaining module 410 may retrieve the at least a portion of the non-image information associated with the first image and/or the subject from the storage device. In some embodiments, the obtaining module 410 may obtain the non-image information, such as imaging parameters, from an imaging device (e.g., the imaging device 110). In some embodiments, the obtaining module 410 may obtain the non-image information from different devices.

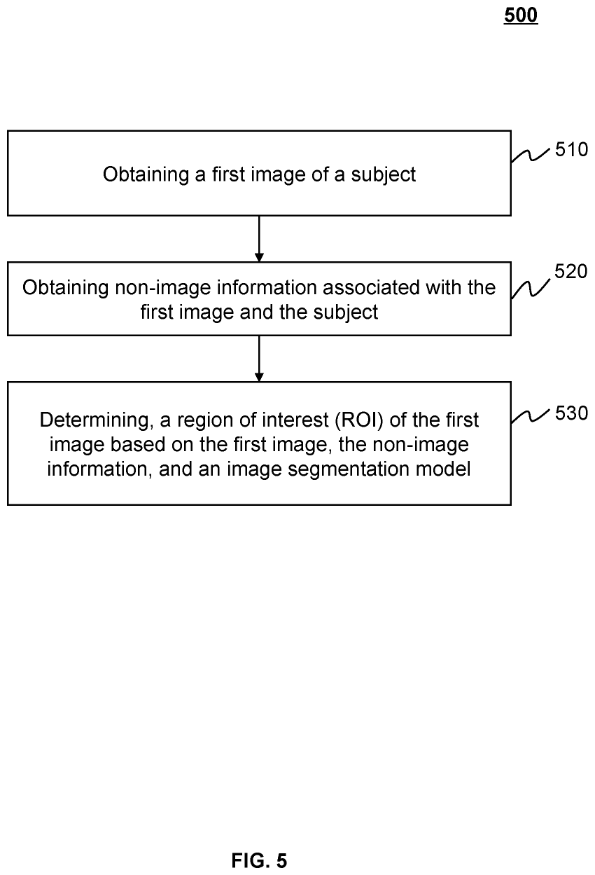

The determination module 420 may be configured to determine a region of interest (ROI) of the first image based on the first image, the non-image information, and an image segmentation model. The image segmentation model may include at least one neural network model that is configured to perform an image segmentation operation on the first image of the subject and determine a region of interest (ROI) of the first image. In some embodiments, the image segmentation model may include only a single neural network model. For example, the determination module 420 may input the first image, the non-image information, and an image segmentation model into the single neural network model, and the single neural network model may process the first image and the non-image information to determine the ROI of the first image. In some embodiments, the image segmentation model may include a plurality of neural network models that are sequentially connected or parallelly connected. For example, the image segmentation model may include two models. A first model of the image segmentation model may be configured to process the non-image information to obtain a processed result of the non-image information. A second model of the image segmentation model may be configured to segment the first image based on the processed result of the non-image information by the first model. For instance, the determination module 420 may directly input the non-image information associated with the first image and/or the subject into the first model, and the first model may output a second image (or referred to as an auxiliary image) of the subject. After obtaining the second image from the first model, the determination module 420 may segment the first image to determine the ROI based on the second image and the first image. More descriptions regarding the image segmentation model and the generation of the image segmentation model may be found elsewhere in the present disclosure (e.g., FIGS. 5-8 and the descriptions thereof).

As illustrated in FIG. 4B, the processing device 120B may include an obtaining module 450 and a model training module 460.

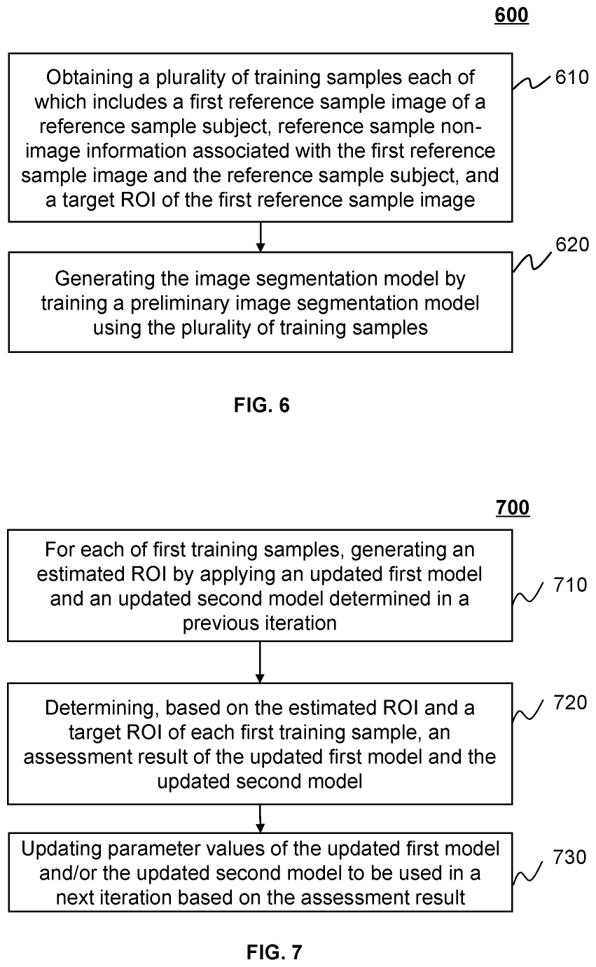

The obtaining module 450 may be configured to obtain a plurality of training samples. In some embodiments, a training sample may be previously generated and stored in a storage device (e.g., the storage device 130, the storage 220, the storage 390, or an external database). The obtaining module 450 may retrieve the training sample directly from the storage device. In some embodiments, at least a portion of a training sample may be generated by the obtaining module 450. Merely by way of example, an imaging scan may be performed on a sample subject to acquire a first sample image of the sample subject. The obtaining module 450 may acquire the first sample image of the sample subject from a storage device where the first sample image is stored. Additionally or alternatively, the obtaining module 450 may determine a target ROI of the first sample image. The target ROI of the first sample image may be determined by performing on the first sample image according to an image segmentation technique. In some embodiments, the training samples (or a portion thereof) may need to be preprocessed before being used in training the image segmentation model. More descriptions regarding the acquisition of the training samples may be found elsewhere in the present disclosure (e.g., operation 610 in FIG. 6 and the descriptions thereof).

The model training module 460 may be configured to generate an image segmentation model by training a preliminary image segmentation model using the plurality of training samples. In some embodiments, the preliminary image segmentation model may only include a single model. For example, the model training module 460 may initialize parameter value(s) of the model parameter(s) of the preliminary image segmentation model, and train the preliminary image segmentation model according to a machine learning algorithm as described elsewhere in this disclosure (e.g., FIG. 5 and the relevant descriptions). In some embodiments, the preliminary image segmentation model may include a plurality of sub-preliminary models. For example, the preliminary image segmentation model may include a first preliminary model and a second preliminary model downstream to the first preliminary model. The first preliminary model may be configured to transform sample non-image information into an image format (e.g., a second sample image, or referred to as a sample auxiliary image). The second preliminary model may be configured to segment a first sample image of a sample subject. In some embodiments, after the model training module 460 initializes parameter value(s) of the model parameter(s) of the first preliminary model and the second preliminary model, the model training module 460 may determine the first model and the second model simultaneously based on the first preliminary model, the second preliminary model, and the plurality of training samples to generate the image segmentation model. Alternatively, the training module 460 may determine the first model and the second model successively based on the first preliminary model, the second preliminary model, and the plurality of training samples to generate the image segmentation model. More descriptions regarding the generation of the image segmentation model may be found elsewhere in the present disclosure (e.g., operation 620 in FIG. 6 and the descriptions thereof).

It should be noted that the above description is merely provided for the purposes of illustration, and not intended to limit the scope of the present disclosure. Apparently, for persons having ordinary skills in the art, multiple variations and modifications may be conducted under the teachings of the present disclosure. However, those variations and modifications do not depart from the scope of the present disclosure. Each of the modules described above may be a hardware circuit that is designed to perform certain actions, e.g., according to a set of instructions stored in one or more storage media, and/or any combination of the hardware circuit and the one or more storage media.

In some embodiments, the processing device 120A and/or the processing device 120B may share two or more of the modules, and any one of the modules may be divided into two or more units. For instance, the processing devices 120A and 120B may share a same obtaining module, that is, the obtaining module 410 and the obtaining module 450 are a same module. In some embodiments, the processing device 120A and/or the processing device 120B may include one or more additional modules, such as a storage module (not shown) for storing data. In some embodiments, the processing device 120A and the processing device 120B may be integrated into one processing device 120.

FIG. 5 is a flowchart illustrating an exemplary process 500 for image segmentation according to some embodiments of the present disclosure. In some embodiments, process 500 may be implemented as a set of instructions (e.g., an application) stored in a storage device (e.g., the storage device 130, the storage 220, and/or the storage 390). The processing device 120A (e.g., the processor 210, the CPU 340, and/or one or more modules illustrated in FIG. 4A) may execute the set of instructions, and when executing the instructions, the processing device 120A may be configured to perform the process 500. The operations of the illustrated process presented below are intended to be illustrative. In some embodiments, the process 500 may be accomplished with one or more additional operations not described and/or without one or more of the operations discussed. Additionally, the order of the operations of process 500 illustrated in FIG. 5 and described below is not intended to be limiting.

In 510, the processing device 120A (e.g., the obtaining module 410) may obtain a first image of a subject.

The subject may be biological or non-biological. For example, the subject may include a patient, a man-made subject, etc. As another example, the subject may include a specific portion, organ, and/or tissue of the patient as described elsewhere in the present disclosure (e.g., FIG. 1 and the descriptions thereof).

In some embodiments, the first image of the subject may include a representation of the subject. For example, the first image of the subject may be a two-dimensional (2D) image, a three-dimensional (3D) image, a four-dimension (4D) image (e.g., a time series of 3D images), or the like, or a combination thereof. The first image may include a CT image, an MRI image, a PET image, a SPECT image, an ultrasound image, an X-ray image, an MRI-CT image, a PET-MRI image, a SPECT-MRI image, a DSA-MRI image, a PET-CT image, a SPECT-CT image, an XR image, or the like, or any combination thereof. In some embodiments, the first image of the subject may be obtained by scanning the subject using an imaging device (e.g., the imaging device 110 of the imaging system 100). For example, the imaging device 110 may acquire the first image of the subject and transmit the acquired first image of the subject to the processing device 120. As another example, the first image of the subject may be previously generated and stored in a storage device (e.g., the storage device 130, the storage 220, etc.), and the processing device 120A may retrieve the first image of the subject from the storage device. As a further example, the first image of the subject may be generated by the processing device 120A. The processing device 120 may process original image data (or an original image determined based on the original image data) of the subject obtained from the imaging device 110 to obtain the first image. For example, the processing device 120A may perform one or more correction operations (e.g., a random correction, a detector normalization, a scatter correction, an attenuation correction, etc.) on the original image data to obtain the first image of the subject. For instance, the detector normalization may be performed to correct variations in detector sensitivities, thereby reducing or eliminating an artifact caused by the variations in the original image data. As another example, the processing device 120A may perform image resizing, image resampling, and image normalization on the original image data (or an original image determined based on the original image data) to obtain the first image.

In 520, the processing device 120A (e.g., the obtaining module 410) may obtain non-image information associated with the first image and/or the subject.

The non-image information associated with the first image and/or the subject may refer to information other than image data and/or image information that is used for generating the first image. In some embodiments, the subject may be biological, and the non-image information may include biological information of the subject, image acquisition information of the first image, information relating to a user associated with the first image or the subject, or the like, or any combination thereof. In some embodiments, the biological information of the subject may be any biological characteristics of the subject that may affect a segmentation result of the first image. Exemplary biological information may include a gender, an age, a weight, a health condition (e.g., a disease, a disease stage, etc.), vital signs (e.g., a body temperature, a heart rate, a blood pressure, etc.) of the biological subject at the time of image acquisition (when the subject is scanned to provide the first image or the original image data on the basis of which the first image is obtained), or the like, or any combination. In some embodiments, the image acquisition information may be any information relating to the acquisition of the first image (or the original image data). Exemplary image acquisition information may include a place (e.g., a hospital) where the first image is acquired, information (e.g., a type, a model, a manufacturer, etc.) of an imaging device that captures the first image (or the original image data), an imaging parameter (e.g., a pose of the subject when the imaging device acquires the first image (or the original image data), an imaging angle of the imaging device and the subject, information of a light source of the imaging device, information of a detector of the imaging device that acquires the first image (or the original image data), etc.), or the like, or any combination thereof. In some embodiments, the user associated with the first image and/or the subject may affect the segmentation result of the first image. For example, the user associated with the first image or the subject may include an operator and/or a technician that operates the imaging device, a technician that segments the first image manually or verifies a segmentation result of the first image, a doctor or nurse of the subject, or the like, or any combination thereof. Different users may have different preferences for operating the imaging device or different preferences/criteria to segment an image.

In some embodiments, the non-image information associated with the first image and/or the subject may be input by a user of the imaging system 100. For example, the user (e.g., an operator, a doctor, a technician, etc.) may input at least a portion of the non-image information associated with the first image and/or the subject through an inputting device (e.g., a mouse, a keyboard, etc.). In some embodiments, at least a portion of the non-image information associated with the first image and/or the subject may be previously stored in a storage device (e.g., the storage device 130, the storage 220, etc.), and the processing device 120A may retrieve the at least a portion of the non-image information associated with the first image and/or the subject from the storage device. For example, at least a portion of non-image information associated with a first image and a subject may be previously stored in the storage device 130 when the first image (or the original image data) is acquired, and the processing device 120A may retrieve the at least a portion of the non-image information associated with the first image and/or the subject from the storage device 130. In some embodiments, the non-image information, such as imaging parameters, may be obtained from an imaging device (e.g., the imaging device 110). In some embodiments, the non-image information may be obtained from different devices. For example, information relating to the user associated with the image or the subject and/or the biological information of the subject may be input manually or retrieved from a record of the subject (e.g., an appointment information of the subject, a medical record of the subject, past visit information of the subject), and the image acquisition information of the image may be obtained from the imaging device 110 or the storage device 130.

In 530, the processing device 120A (e.g., the determination module 420) may determine a region of interest (ROI) of the first image based on the first image, the non-image information, and an image segmentation model.

The ROI of the first image may include a representation of an ROI of the subject. For example, the ROI of the subject may include a target and/or an organ at risk (OAR) near the target. The target may include a region of the subject including at least part of malignant tissue (e.g., a tumor, a cancer-ridden organ, a non-cancerous target of radiation therapy, etc.). For example, the target may be a lesion (e.g., a tumor, a lump of abnormal tissue), an organ with a lesion, a tissue with a lesion, or any combination thereof, that needs to be treated by, e.g., radiation. The OAR may include an organ and/or a tissue that are close to the target and not intended to be subjected to the treatment, but under the risk of being damaged or affected by the treatment due to its proximity to the target. In some embodiments, the ROI may be marked with feature information of the ROI in the first image. Exemplary feature information may include a position, a contour, a shape, a height, a width, a thickness, an area, a ratio of height to width, or the like, or any combination thereof, of the ROI. In some embodiments, a plurality of ROIs of the first image may be determined. Different ROIs may represent different targets.

As used herein, a representation of an object (e.g., a subject, a patient, or a portion thereof) in an image may be referred to as “object” for brevity. For instance, a representation of an organ, tissue (e.g., a heart, a liver, a lung), or an ROI in an image may be referred to as the organ, tissue, or ROI, for brevity. Further, an image including a representation of an object, or a portion thereof, may be referred to as an image of the object, or a portion thereof, or an image including the object, or a portion thereof, for brevity. Still further, an operation performed on a representation of an object, or a portion thereof, in an image may be referred to as an operation performed on the object, or a portion thereof, for brevity. For instance, a segmentation of a portion of an image including a representation of an ROI from the image may be referred to as a segmentation of the ROI for brevity.

In some embodiments, the image segmentation model may refer to a process or an algorithm for segmenting the first image. For example, the image segmentation model may include at least one neural network model that is configured to perform an image segmentation operation on the first image of the subject and determine a region of interest (ROI) of the first image. In some embodiments, the image segmentation model may include only a single neural network model. The single neural network model may process the first image and the non-image information to determine the ROI of the first image. For example, the image segmentation model may include a convolutional neural network (CNN) model, a recurrent neural network (RNN) model, a long short term memory (LSTM) network model, a fully convolutional neural network (FCN) model, a generative adversarial network (GAN) model, a radial basis function (RBF) machine learning model, a DeepMask model, a SegNet model, a dilated convolution model, a conditional random fields as recurrent neural networks (CRFasRNN) model, a pyramid scene parsing network (pspnet) model, or the like, or any combination thereof.

In some embodiments, the image segmentation model may include a plurality of neural network models that are sequentially connected or parallelly connected. For example, the image segmentation model may include two models. A first model of the image segmentation model may be configured to process the non-image information to obtain a processed result of the non-image information. A second model of the image segmentation model may be configured to segment the first image based on the processed result of the non-image information by the first model.

In some embodiments, the first model may be configured to transform the non-image information into a specific format (e.g., an image format, a vector format, etc.). For example, the first model may be a decoder to transform the non-image information into a second image (or referred to as an auxiliary image). The second image (or referred to as the auxiliary image) of the subject may be an image that represents the non-image information associated with the first image and/or the subject. For example, the processing device 120A may directly input the non-image information associated with the first image and/or the subject into the first model, and the first model may output a second image (or referred to as the auxiliary image) of the subject. Alternatively, the processing device 120A may preprocess the non-image information associated with the first image and/or the subject. For example, the processing device 120A may determine a vector based on the non-image information, and further determine the second image by inputting the vector into the first model. The output of the first model may be the second image (or referred to as the auxiliary image).

In some embodiments, the vector may include one or more feature values corresponding to each piece of the non-image information associated with the first image and/or the subject in a certain sequence. In some embodiments, the vector may be represented by Equation (1):

a=[x₁,x₂, . . . ,x_{M}], (1)

where a refers to a vector corresponding to non-image information associated with a first image and a subject; x_{M} refers to a value or a feature value of an M-th piece of information of the non-image information, wherein M is a positive integer. For instance, the subject is a patient, or a part of the patient, and the non-image information associated with the first image and/or the subject includes a gender of the patient, an age of the patient, a weight of the patient, a type of the imaging device capturing the first image (or the original image data of the first image), and a user associated with the first image and/or the patient. A vector corresponding to the non-image information associated with the first image and/or the patient may be represented by a=[x₁, x₂, x₃, x₄, x₅], where x₁, x₂, x₃, x₄, and x₅ may respectively represent the gender of the patient, the age of the patient, the weight of the patient, information of the imaging device, and information of the user.

In some embodiments, the processing device 120A may determine the feature value of each piece of information of the non-image information according to a predetermined rule. In some embodiments, a feature value may be an actual value or an assigned value correspond to a piece of information of the non-image information. For example, the age of the patient may be an actual value (e.g., 1, 5, 10, 20, 30, 40, 50, 60, 70, etc.). Alternatively, different ages may be divided into different age groups. For instance, a patient may be assigned to a specific value as the feature value for the age information. For example, as for the age information, the feature value of 1 represents an age period of 0-9 years old, the feature value of 2 represents an age period of 10-19 years old, the feature value of 3 represents an age period of 20-29 years old, the feature value of 4 represents an age period of 30-39 years old, the feature value of 5 represents an age period of 40-49 years old, the feature value of 6 represents an age period of 50-59 years old, the feature value of 7 represents an age period of 60-69 years old, etc. As another example, a feature value representing the gender of the patient may be assigned to a specific value. For example, as for the gender information, the feature value of a female patient may be 0, while the feature value of a male patient may be 1. As still another example, different users or different imaging devices may be assigned to different feature values. In some embodiments, if a piece of the non-image information does not have a corresponding feature value, the processing device 120A may determine the feature value of the piece of the non-image information as a default value. For example, if a place (e.g., a hospital) where the first image is acquired is a new place which has not been assigned to a feature value, the feature value corresponding to the new place may be assigned to 0 (other previous presented places are assigned to a positive integer). In some embodiments, the default value may be predetermined and stored in a storage device (e.g., the storage device 130, the storage 220, etc.). Accordingly, the non-image information may be assigned a plurality of feature values to generate the vector of the non-image information.

In some embodiments, the first model may be a process or an algorithm that is configured to transform non-image data into an image format. For example, the first model may include a convolutional neural network (CNN) model, a deep convolution-deconvolution network (e.g., an encoder-decoder), a U-shaped convolutional neural network (U-Net), a V-shaped convolutional neural network (V-Net), a residual network (Res-Net), a residual dense network (Red-Net), a deep insight-feature selection algorithm, or the like, or any combination thereof.

In some embodiments, after obtaining the second image from the first model, the processing device 120A may segment the first image to determine the ROI based on the second image and the first image. For example, the first image and the second image representing the non-image information relating to the first image or the subject may be input into the second model. The output of the second model may be the first image in which the ROI is identified. As another example, the output of the second model may need to be further processed to obtain the ROI of the first image. For example, the processing device 120A may perform one or more correction operations (e.g., a random correction, a detector normalization, and/or a scatter correction, an attenuation correction, etc.) on the output of the second model to obtain the ROI of the first image.

In some embodiments, the second model may be a process or an algorithm that is configured to segment an image to obtain an ROI of the image. For example, the second model may include a convolutional neural network (CNN) model, a generative adversarial network (GAN) model, or any other suitable type of model. Exemplary CNN models may include a Fully Convolutional Network, such as a V-NET model, a U-NET model, etc. Exemplary GAN models may include a pix2pix model, a Wasserstein GAN (WGAN) model, a circle GAN model, etc. In some embodiments, the second model may be a multichannel neural network. The multichannel neural network may include a plurality of channels, each of which corresponds to an input. For example, the second model may include at least one channel corresponding to the first image and at least one channel corresponding to the non-image information relating to the first image.

In some embodiments, the processing device 120A (e.g., the obtaining module 410) may obtain the image segmentation model (e.g., the first model, the second model) from one or more components of the imaging system 100 (e.g., the storage device 130, the terminals(s) 140) or an external source via a network (e.g., the network 150). For example, the image segmentation model may be previously generated by a computing device (e.g., the processing device 120B), and stored in a storage device (e.g., the storage device 130, the storage 220, and/or the storage 390) of the imaging system 100. The processing device 120A may access the storage device and retrieve the image segmentation model. In some embodiments, the image segmentation model may be generated according to a machine learning algorithm. The machine learning algorithm may include but not be limited to an artificial neural network algorithm, a deep learning algorithm, a decision tree algorithm, an association rule algorithm, an inductive logic programming algorithm, a support vector machine algorithm, a clustering algorithm, a Bayesian network algorithm, a reinforcement learning algorithm, a representation learning algorithm, a similarity and metric learning algorithm, a sparse dictionary learning algorithm, a genetic algorithm, a rule-based machine learning algorithm, or the like, or any combination thereof. The machine learning algorithm used to generate the image segmentation model may be a supervised learning algorithm, a semi-supervised learning algorithm, an unsupervised learning algorithm, etc. In some embodiments, the image segmentation model may be generated by a computing device (e.g., the processing device 120B) by performing a process (e.g., process 600) for generating an image segmentation model disclosed herein. More descriptions regarding the generation of the image segmentation model may be found elsewhere in the present disclosure. See, e.g., FIGS. 6-8 and relevant descriptions thereof.

In some embodiments, the processing device 120A may transmit the ROI of the first image to a terminal (e.g., a terminal 140) for display. Optionally, a user of the terminal may input a response regarding the displayed ROI of the first image via, for example, an interface of the terminal. For example, the user may evaluate whether the ROI of the first image satisfies a preset condition (e.g., the accuracy of the ROI of the first image is satisfying). According to the evaluation result, the user may send a request to the processing device 120A. For example, the request may include adjusting imaging parameters of the imaging device 110, adjusting a pose of the subject during imaging, rescanning the subject, repeating or redoing the image segmentation, or the like, or any combination thereof.

It should be noted that the above description regarding the process 500 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations of the process 500 may be omitted and/or one or more additional operations may be added. For example, a storing operation may be added elsewhere in the process 500. In the storing operation, the processing device 120A may store information and/or data (e.g., the first image, the second image, the image segmentation model, the ROI, etc.) associated with the imaging system 100 in a storage device (e.g., the storage device 130) disclosed elsewhere in the present disclosure.

FIG. 6 is a flowchart illustrating an exemplary process 600 for generating an image segmentation model according to some embodiments of the present disclosure. In some embodiments, the process 600 may be implemented as a set of instructions (e.g., an application) stored in a storage device (e.g., the storage device 130, storage 220, and/or storage 390). The processing device 120B (e.g., the processor 210, the CPU 340, and/or one or more modules illustrated in FIG. 4B) may execute the set of instructions, and when executing the instructions, the processing device 120B may be configured to perform the process 600. The operations of the illustrated process presented below are intended to be illustrative. In some embodiments, the process 600 may be accomplished with one or more additional operations not described and/or without one or more of the operations discussed. Additionally, the order of the operations of process 600 illustrated in FIG. 6 and described below is not intended to be limiting. In some embodiments, the image segmentation model described in connection with operation 530 in FIG. 5 may be obtained according to the process 600. In some embodiments, the process 600 may be performed by another device or system other than the imaging system 100, e.g., a device or system of a vendor of a manufacturer. For illustration purposes, the implementation of the process 600 by the processing device 120B is described as an example.

In 610, the processing device 120B (e.g., the obtaining module 450) may obtain a plurality of training samples. Each of the plurality of training samples may include a first sample image of a sample subject, sample non-image information associated with the first sample image and/or the sample subject, and a target ROI of the first sample image.

As used herein, a sample subject refers to an object that is used for training the image segmentation model. The sample subject may be of the same type or a different type of object as the subject as described in connection with FIG. 5. For example, if the image segmentation model is used to perform image segmentation on a first image of a patient (or a portion thereof), the sample subject may be another patient. The first sample image of a sample subject refers to a first image of the sample subject. The sample non-image information associated with the first sample image and/or the sample subject refers to non-image information associated with the first sample image and/or the sample subject. The target ROI of the first sample image refers to a ground truth first image that is generated by performing an image segmentation on the sample first image using an image segmentation technique or manually determined by a user (e.g., a doctor, an operator, a technician, etc.). For example, the target ROI of the first sample image may be generated according to an image segmentation technique (e.g., a region-based segmentation, an edge-based segmentation, a wavelet transform segmentation, a mathematical morphology segmentation, an artificial neural network-based segmentation, a genetic algorithm-based segmentation, or the like, or a combination thereof). As another example, the target ROI of the first sample image may be marked by a skilled physician. As still another example, the target ROI of the first sample image may be firstly generated according to the image segmentation technique, and then be adjusted or corrected by the skilled physician.

In some embodiments, a training sample may be previously generated and stored in a storage device (e.g., the storage device 130, the storage 220, the storage 390, or an external database). The processing device 120B may retrieve the training sample directly from the storage device. In some embodiments, at least a portion of a training sample may be generated by the processing device 120B. Merely by way of example, an imaging scan may be performed on a sample subject to acquire a first sample image of the sample subject. The processing device 120B may acquire the first sample image of the sample subject from a storage device where the first sample image is stored. Additionally or alternatively, the processing device 120B may determine a target ROI of the first sample image. The target ROI of the first sample image may be determined by performing on the first sample image according to an image segmentation technique.

In some embodiments, the training samples (or a portion thereof) may need to be preprocessed before being used in training the image segmentation model. For example, for a training sample, the processing device 120B may perform image resizing, image resampling, and image normalization on the first sample image. As another example, for a training sample, the processing device 120B may determine a sample vector of the sample non-image information associated with the first sample image and the sample subject.

In 620, the processing device 120B (e.g., the training module 460) may generate the image segmentation model by training a preliminary image segmentation model using the plurality of training samples.

In some embodiments, the preliminary image segmentation model may be an initial model (e.g., a machine learning model) before being trained. Exemplary machine learning models may include a convolutional neural network (CNN) model, a recurrent neural network (RNN) model, a long short term memory (LSTM) network model, a fully convolutional neural network (FCN) model, a generative adversarial network (GAN) model, a radial basis function (RBF) machine learning model, a DeepMask model, a SegNet model, a dilated convolution model, a conditional random fields as recurrent neural networks (CRFasRNN) model, a pyramid scene parsing network (pspnet) model, or the like, or any combination thereof.

In some embodiments, the preliminary image segmentation model may include a multi-layer structure. For example, the preliminary image segmentation model may include an input layer, an output layer, and one or more hidden layers between the input layer and the output layer. In some embodiments, the hidden layers may include one or more convolution layers, one or more rectified-linear unit layers (ReLU layers), one or more pooling layers, one or more fully connected layers, or the like, or any combination thereof. As used herein, a layer of a model refers to an algorithm or a function for processing input data of the layer. Different layers may perform different kinds of processing on their respective input. A successive layer may use output data from a previous layer of the successive layer as input data. In some embodiments, the convolutional layer may include a plurality of kernels, which may be used to extract a feature. In some embodiments, each kernel of the plurality of kernels may filter a portion (i.e., a region). The pooling layer may take an output of the convolutional layer as an input. The pooling layer may include a plurality of pooling nodes, which may be used to sample the output of the convolutional layer, so as to reduce the computational load of data processing and accelerate the speed of data processing speed. In some embodiments, the size of the matrix representing the inputted data may be reduced in the pooling layer. The fully connected layer may include a plurality of neurons. The neurons may be connected to the pooling nodes in the pooling layer. In the fully connected layer, a plurality of vectors corresponding to the plurality of pooling nodes may be determined based on a training sample, and a plurality of weighting coefficients may be assigned to the plurality of vectors. The output layer may determine an output based on the vectors and the weighting coefficients obtained from the fully connected layer.

In some embodiments, each of the layers may include one or more nodes. In some embodiments, each node may be connected to one or more nodes in a previous layer. The number (or count) of nodes in each layer may be the same or different. In some embodiments, each node may correspond to an activation function. As used herein, an activation function of a node may define an output of the node given input or a set of inputs. In some embodiments, each connection between two of the plurality of nodes in the preliminary image segmentation model may transmit a signal from one node to another node. In some embodiments, each connection may correspond to a weight coefficient. A weight coefficient corresponding to a connection may be used to increase or decrease the strength or impact of the signal at the connection.

The preliminary image segmentation model may include one or more model parameters, such as architecture parameters, learning parameters, etc. In some embodiments, the preliminary image segmentation model may only include a single model. For example, the preliminary image segmentation model may be a CNN model and exemplary model parameters of the preliminary model may include the number (or count) of layers, the number (or count) of kernels, a kernel size, a stride, a padding of each convolutional layer, a loss function, or the like, or any combination thereof. Before training, the model parameter(s) of the preliminary image segmentation model may have their respective initial values. For example, the processing device 120B may initialize parameter value(s) of the model parameter(s) of the preliminary image segmentation model.

In some embodiments, the preliminary image segmentation model may be trained according to a machine learning algorithm as described elsewhere in this disclosure (e.g., FIG. 5 and the relevant descriptions). For example, the processing device 120B may generate the image segmentation model according to a supervised machine learning algorithm by performing one or more iterations to iteratively update the model parameter(s) of the preliminary image segmentation model.

In some embodiments, the preliminary image segmentation model may include a plurality of sub-preliminary models. For example, the preliminary image segmentation model may include a first preliminary model and a second preliminary model downstream to the first preliminary model. The first preliminary model may be configured to transform sample non-image information into an image format (e.g., a second sample image, a sample auxiliary image). In some embodiments, the first preliminary model may be a convolutional neural network (CNN) model, a deep convolution-deconvolution network (e.g., an encoder-decoder), a U-shaped convolutional neural network (U-Net), a V-shaped convolutional neural network (V-Net), a residual network (Res-Net), a residual dense network (Red-Net), a deep insight-feature selection algorithm, or the like. The first preliminary model may include one or more model parameters, such as architecture parameters, learning parameters, etc. For example, the first preliminary model may be a CNN model and exemplary model parameters of the first preliminary model may include the number (or count) of layers, the number (or count) of kernels, a kernel size, a stride, a padding of each convolutional layer, a loss function, or the like, or any combination thereof. Before training, the model parameter(s) of the first preliminary model may have their respective initial values. For example, the processing device 120B may initialize parameter value(s) of the model parameter(s) of the first preliminary model.

The second preliminary model may be configured to segment a first sample image of a sample subject. In some embodiments, the second preliminary model may be a convolutional neural network (CNN) model, a generative adversarial network (GAN) model, or any other suitable type of model. Exemplary CNN models may include a Fully Convolutional Network, such as a V-NET model, a U-NET model, etc. Exemplary GAN models may include a pix2pix model, a Wasserstein GAN (WGAN) model, etc. The second preliminary model may include one or more model parameters, such as architecture parameters, learning parameters, etc. For example, the second preliminary model may be a CNN model and exemplary model parameters of the preliminary model may include the number (or count) of layers, the number (or count) of kernels, a kernel size, a stride, a padding of each convolutional layer, a loss function, or the like, or any combination thereof. Before training, the model parameter(s) of the second preliminary model may have their respective initial values. For example, the processing device 120B may initialize parameter value(s) of the model parameter(s) of the second preliminary model.

In some embodiments, the processing device 120B (e.g., the training module 460) may determine the first model and the second model simultaneously based on the first preliminary model, the second preliminary model, and the plurality of training samples to generate the image segmentation model. Merely by way of example, the processing device 120B may train the first preliminary model and the second preliminary model by iteratively and jointly updating the parameters of the first preliminary model and the second preliminary model based on the training samples. In some embodiments, the generating of the first model and the second model may include one or more iterations, wherein at least one of the iteration(s) may include one or more operations of process 700 as described in connection with FIG. 7.

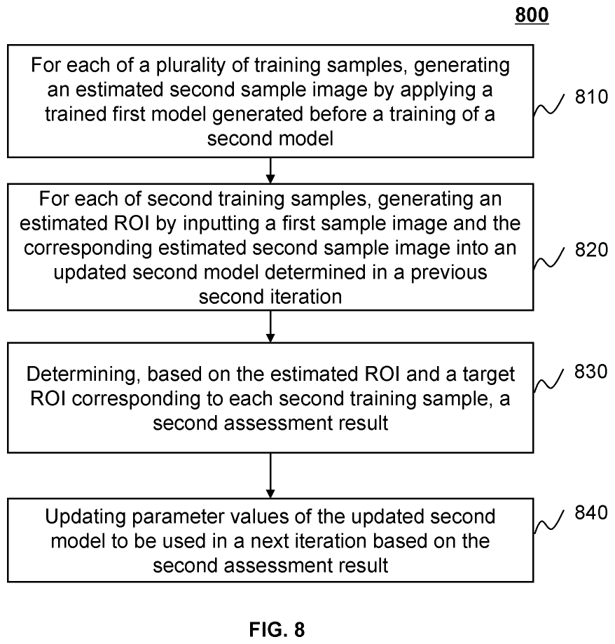

Alternatively, the processing device 120B (e.g., the training module 460) may determine the first model and the second model successively based on the first preliminary model, the second preliminary model, and the plurality of training samples to generate the image segmentation model. For example, the processing device 120B may determine the first model by training the first preliminary model using the sample non-image information of the plurality of training samples and a plurality of target second sample images (or referred to as target sample auxiliary images) corresponding to the sample non-image information. In some embodiments, the plurality of target second sample images may be determined based on the corresponding sample non-image information according to an image coding algorithm other than the first model disclosed herein. The processing device 120B may determine, based on the first model, the second model by training the second preliminary model using the first sample images and the target ROIs of the first sample images of the plurality of training samples, in which the first sample images are input to the first model and the output thereof are used as part of the input for the training of the second model. In some embodiments, the first preliminary model and the second preliminary model may be trained according to a machine learning algorithm as described elsewhere in this disclosure (e.g., FIG. 5 and the relevant descriptions). For example, the processing device 120B may generate the first model according to a supervised machine learning algorithm by performing one or more iterations to iteratively update model parameter(s) of the first preliminary model. As another example, the processing device 120B may generate the second model according to a supervised machine learning algorithm by performing one or more iterations to iteratively update model parameter(s) of the second preliminary model. The training of the second preliminary model may include one or more iterations, wherein at least one of the iteration(s) may include one or more operations of process 800 as described in connection with FIG. 8.

It should be noted that the above description regarding process 600 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be added or omitted. For example, the image segmentation model may be stored in a storage device (e.g., the storage device 130) disclosed elsewhere in the present disclosure for further use (e.g., in an image segmentation model of a first image as described in connection with FIG. 5). As another example, after the image segmentation model is generated, the processing device 120B may further test the image segmentation model using a set of testing images. Additionally or alternatively, the processing device 120B may update the image segmentation model periodically or irregularly based on one or more training images that become available (e.g., new first sample images, new sample non-image information associated with the first sample image and the sample subject, and a target ROI of the new first sample image).

FIG. 7 is a flowchart illustrating an exemplary training process for determining a first model and a second model of an image segmentation model according to some embodiments of the present disclosure. In some embodiments, process 700 may be implemented as a set of instructions (e.g., an application) stored in the storage device 130, storage 220, or storage 390. The processing device 120B (e.g., the processor 210, the CPU 340, and/or one or more modules illustrated in FIG. 4B) may execute the set of instructions, and when executing the instructions, the processing device 120 may be configured to perform the process 700. The operations of the illustrated process presented below are intended to be illustrative. In some embodiments, the process 700 may be accomplished with one or more additional operations not described and/or without one or more of the operations discussed. Additionally, the order of the operations of process 700 illustrated in FIG. 7 and described below is not intended to be limiting. In some embodiments, one or more operations of process 700 may be performed to achieve at least part of operation 620 as described in connection with FIG. 6. For example, the process 700 may be performed to achieve a current iteration in training the preliminary image segmentation model, during which the first preliminary model and the second preliminary model of the preliminary image segmentation model are trained in parallel. The current iteration may be performed based on at least some of the training samples (or referred to as first training samples). In some embodiments, a same set or different sets of first training samples may be used in different iterations in training the preliminary image segmentation.

In 710, for each of the first training samples, the processing device 120B (e.g., the training module 460) may generate an estimated ROI by applying an updated first model and an updated second model determined in a previous iteration.

During the application of the updated first model and the updated second model on a first training sample, the updated first model may be configured to receive sample non-image information (or a vector of the sample non-image information) in the first training sample, and the updated second model may be configured to receive a first sample image and an output sample second image of the updated first model. The estimated ROI may be an output of the updated second model.

In 720, the processing device 120B (e.g., the training module 460) may determine, based on the estimated ROI and a target ROI of each first training sample, an assessment result of the updated first model and the updated second model.

The assessment result may indicate an accuracy and/or efficiency of the updated image segmentation model (including the updated first model and the updated second model). In some embodiments, the processing device 120B may determine the assessment result by assessing a loss function that relates to the updated first model and the updated second model. For example, a value of an overall loss function may be determined to measure an overall difference between the estimated ROI and the target ROI of each of the first training samples. The processing device 120B may determine the assessment result based on the value of the overall loss function. In some embodiments, the processing device 120B may determine the assessment result by assessing a first loss function that relates to the updated first model and a second loss function that relates to the updated second model. For example, a value of the first loss function may be determined to measure a difference between an estimated second sample image output from the updated first model and a target second sample image of each of the first training samples; a value of the second loss function may be determined to measure a difference between the estimated ROI and the target ROI of each of the first training samples. The processing device 120B may determine an overall value of the first loss function and the second loss function according to an algorithm (e.g., a sum, a weighted sum of the first loss function and the second loss function, etc.) of each of the first training samples. The processing device 120B may determine the assessment result based on the overall value.

Additionally or alternatively, the assessment result may be associated with the amount of time it takes for the updated image segmentation model to generate the estimated ROI of each first training sample. For example, the shorter the amount of time is, the more efficient the updated image segmentation model is. In some embodiments, the processing device 120B may determine the assessment result based on the value relating the loss function(s) aforementioned and/or the efficiency.

In some embodiments, the assessment result may include a determination as to whether a termination condition is satisfied in the current iteration. In some embodiments, the termination condition may relate to the value of the overall loss function and/or the overall value (or the values) of the first loss function and the second loss function. For example, the termination condition may be deemed satisfied if the value of the overall loss function is minimal or smaller than a threshold (e.g., a constant). As another example, the termination condition may be deemed satisfied if the value of the overall loss function converges. In some embodiments, convergence may be deemed to have occurred if, for example, the variation of the values of the overall loss function in two or more consecutive iterations is equal to or smaller than a threshold (e.g., a constant), a certain count of iterations have been performed, or the like. Additionally or alternatively, the termination condition may include that the amount of time it takes for the updated image segmentation model to generate the estimated ROI of each first training sample is smaller than a threshold.

In some embodiments, in response to a determination that the termination condition is satisfied, the processing device 120B may designate the updated first model and the updated second model as the first model and the second model, respectively, and accordingly the image segmentation model is generated. In response to a determination that the termination condition is not satisfied, the processing device 120B may proceed to 730, in which the processing device 120B (e.g., the training module 460) or an optimizer may update the parameter values of the updated first model and/or the updated second model to be used in a next iteration based on the assessment result.

For example, the processing device 120B or the optimizer may update the parameter value(s) of the updated first model and the updated second model based on the value of the overall loss function according to, for example, a backpropagation algorithm. As another example, for the updated first model (or the updated second model), the processing device 120B may update the parameter value(s) of the model based on the value of the corresponding first loss function (or the corresponding second loss function) and optionally the value(s) the first loss function (or the corresponding second loss function). In some embodiments, a model may include a plurality of parameter values, and updating parameter value(s) of the model refers to updating at least a portion of the parameter values of the model.

FIG. 8 is a flowchart illustrating an exemplary process 800 for determining a first model and a second model of an image segmentation according to some embodiments of the present disclosure. In some embodiments, process 800 may be implemented as a set of instructions (e.g., an application) stored in a storage device (e.g., the storage device 130, storage 220, and/or storage 390). The processing device 120B (e.g., the processor 210, the CPU 340, and/or one or more modules illustrated in FIG. 4B) may execute the set of instructions, and when executing the instructions, the processing device 120B may be configured to perform the process 800. In some embodiments, one or more operations of the process 800 may be performed to achieve at least part of operation 620 as described in connection with FIG. 6. For example, the process 800 may be performed to achieve a current iteration in training the preliminary image segmentation model, during which the first preliminary model and the second preliminary model of the preliminary image segmentation model are trained in sequence.

In 810, for each of the plurality of training samples, the processing device 120B (e.g., the training module 460) may generate an estimated second sample image (or referred to as an estimated sample auxiliary image) by applying a trained first model generated before the training of a second model. The estimated second sample image may be an output image of the trained first model.

In some embodiments, the trained first model may be generated by training the first preliminary model using sample non-image information of the plurality of training samples and a plurality of target second sample images corresponding to the sample non-image information of the plurality of training samples. In some embodiments, the plurality of target second sample images may be determined based on the corresponding sample non-image information according to an image coding algorithm other than the first model disclosed herein. The first preliminary model may be trained to provide the trained first model according to a machine learning algorithm as described elsewhere in this disclosure (e.g., FIG. 5 and the relevant descriptions).

In some embodiments, sample non-image information of each of the plurality of training samples may be inputted into the trained first model to generate the estimated second sample image. The processing device 120 may further train the second model using the training samples and the corresponding estimated second sample images. For example, the processing device 120B may initialize the parameter values of the second model before training the second preliminary model. The processing device 120B may train the second model by iteratively updating the parameter values of the second preliminary model based on the first sample images and corresponding estimated second sample images. In some embodiments, the training of the second model may include one or more second iterations. For illustration purposes, a current second iteration including operations 820-840 of the process 800 is described hereinafter. The current second iteration may be performed based on at least some of the training samples (or referred to as second training samples). The second training samples may include one or more same training samples as or different training samples from the first training samples as described in connection with FIG. 7. In some embodiments, a same set or different sets of second training samples may be used in different second iterations in training the second model.

In 820, for each of the second training samples, the processing device 120B (e.g., the training module 460) may generate an estimated ROI by inputting a first sample image and the corresponding estimated second sample image into an updated second model determined in a previous second iteration.

In 830, the processing device 120B (e.g., the training module 460) may determine, based on the estimated ROI and the target ROI corresponding to each second training sample, a second assessment result.

The second assessment result may indicate an accuracy and/or efficiency of the updated second model. In some embodiments, the processing device 120B may determine the second assessment result by assessing a loss function that relates to the trained first model and the updated second model. For example, a value of an overall loss function may be determined to measure an overall difference between the estimated ROI and the target ROI of each of the second training samples. The processing device 120B may determine the second assessment result based on the value of the overall loss function. In some embodiments, the processing device 120B may determine the second assessment result by assessing a first loss function that relates to the trained first model and a second loss function that relates to the updated second model. For example, a value of the first loss function may be determined to measure a difference between an estimated second sample image output from the trained first model and a target second sample image of each of the second training samples; a value of the second loss function may be determined to measure a difference between the estimated ROI and the target ROI of each of the second training samples. The processing device 120B may determine an overall value of the first loss function and the second loss function according to an algorithm (e.g., a sum, a weighted sum of the first loss function and the second loss function, etc.) of each of the second training samples. The processing device 120B may determine the second assessment result based on the overall value.

Additionally or alternatively, the second assessment result may be associated with the amount of second time it takes for the updated second model to generate the estimated ROI of each of the at least some of the plurality of training samples. For example, the shorter the amount of second time is, the more efficient the updated second model is. In some embodiments, the processing device 120B may determine the second assessment result based on the value relating the loss function(s) aforementioned and/or the efficiency. The second assessment result may include a determination as to whether a second termination condition is satisfied in the current second iteration. The determination of the second assessment result may be performed in a similar manner with that of the assessment result as described in connection with FIG. 7, and the descriptions thereof are not repeated here.

In some embodiments, in response to a determination that the second termination condition is satisfied, the processing device 120B may designate the updated second model as the second model, and the trained first model as the first model. In response to a determination that the second termination condition is not satisfied, the processing device 120B may proceed to 840, in which the processing device 120B (e.g., the training module 460) may update the parameter values of the updated second model to be used in a next iteration based on the second assessment result. For example, the processing device 120B may update the parameter value(s) of the updated second model based on the value of the second loss function according to, for example, a backpropagation algorithm. Alternatively, the processing device 120B may retrain the first preliminary model to obtain a new trained first model to be used in the next iteration.

It should be noted that the above descriptions regarding the processes 700 and 800 are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. The operations of the illustrated process presented above are intended to be illustrative. In some embodiments, the process 700 and/or process 800 may be accomplished with one or more additional operations not described and/or without one or more of the operations discussed. Additionally, the order of the operations of the process 700 and/or the process 800 is not intended to be limiting. For example, in process 800, the processing device 120B may further test the trained second model using a set of testing samples to determine whether a testing condition is satisfied. If the testing condition is not satisfied, the process 800 may be performed again to further train the model.

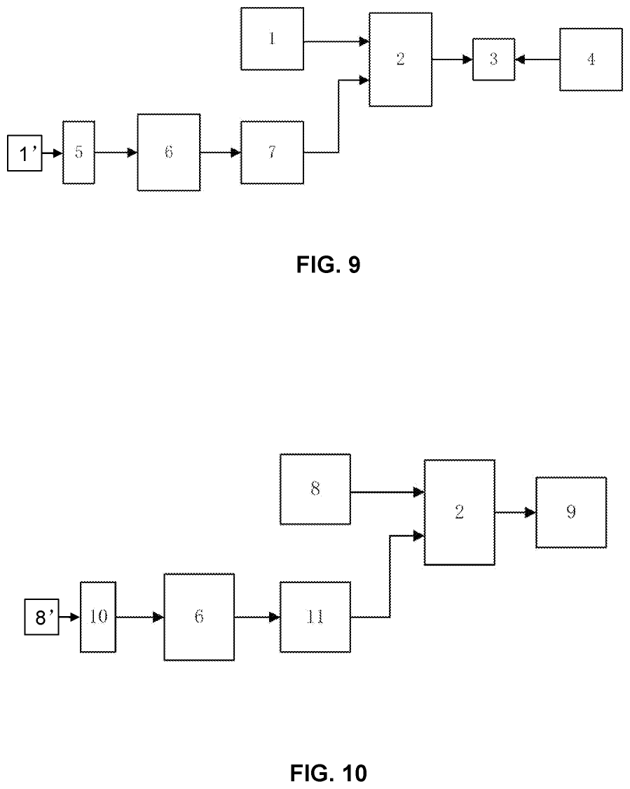

FIG. 9 is a schematic diagram illustrating an exemplary training process for training an image segmentation model according to some embodiments of the present disclosure.

As shown in FIG. 9, a preliminary image segmentation model includes a first preliminary model 6 and a second preliminary model 2. A plurality of training samples, each of which includes a first sample image 1 of a sample subject, sample non-image information 1′ associated with the first sample image 1 and the sample subject, and a target ROI of the first sample image 1, are used for training the first preliminary model 6 and the second preliminary model 2. For example, for each of the plurality of training samples, sample non-image information 1′ associated with the first sample image 1 and a sample subject is transformed into a sample vector 5. The sample vector 5 is input into the first preliminary model 6, and the first preliminary model 6 outputs a second sample image 7 (or referred to as a sample auxiliary image) representing the sample non-image information 1′. The first sample image 1 and the second sample image 7 are input into the second preliminary model 2, and the second preliminary model 2 may output an estimated ROI of the first sample image 1. During each iteration of the training process, a loss function 3 between the estimated ROI of the first sample image 1 and a target ROI 4 of the first sample image 1 may be determined. Based on the loss function 3, the processing device 120B may determine whether a termination condition is satisfied. In response to a determination that the termination condition is satisfied, the processing device 120B may designate a first preliminary model 6 and a second preliminary model 2 updated in a last iteration as a first model and a second model of an image segmentation model, respectively. In response to a determination that the termination condition is not satisfied, the processing device 120B may update at least some of the parameter values of the first preliminary model 6 and the second preliminary model 2 to be used in a next iteration based on the loss function 3.

FIG. 10 is a schematic diagram illustrating an exemplary process of an application of an image segmentation model according to some embodiments of the present disclosure.

As shown in FIG. 10, the image segmentation model includes a first model 6 and a second model 2. An ROI 9 of a first image 8 of a subject may be determined based on the first image 8, non-image information 8′ associated with the first image 8 and/or the subject, the first model 6, and the second model 2. The non-image information 8′ associated with the first image 8 and the subject may be transformed into a vector 10. The processing device 120A may input the vector 10 into the first model 6, and the output of the first model may be a second image 11. The first image 8 and the second image 11 may be input into the second model 2, and the second model 2 may output the ROI 9 of the first image 8.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer-readable media having computer-readable program code embodied thereon.

A non-transitory computer-readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer-readable signal medium may be any computer-readable medium that is not a computer-readable storage medium and that may communicate, propagate, or transport a program for use by or in connection with an instruction execution system, apparatus, or device. Program code embodied on a computer-readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C #, VB. NET, Python or the like, conventional procedural programming languages, such as the “C” programming language, Visual Basic, Fortran, Perl, COBOL, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof to streamline the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A system for image segmentation, comprising:
at least one storage device including a set of instructions; and
at least one processor configured to communicate with the at least one storage device, wherein when executing the set of instructions, the at least one processor is configured to direct the system to perform operations including:
obtaining a first image of a subject;
obtaining non-image information associated with at least one of the first image or the subject; and
determining a region of interest (ROI) of the first image based on the first image, the non-image information, and an image segmentation model.

2. The system of claim 1, wherein the image segmentation model includes a first model configured to transform the non-image information into a second image.

3. The system of claim 2, wherein the determining the ROI of the first image includes:
determining a vector based on the non-image information; and
determining the second image by inputting the vector into the first model.

4. The system of claim 3, wherein the image segmentation model further includes a second model configured to segment the first image based at least on the second image.

5. The system of claim 4, wherein the second model includes a multichannel neural network.

6. The system of claim 1, wherein the non-image information includes at least one of: information relating to a user associated with the first image or the subject, biological information of the subject, or image acquisition information of the first image.

7. The system of claim 1, wherein the image segmentation model is obtained by a training process including:
obtaining a plurality of training samples each of which includes a first sample image of a sample subject, sample non-image information associated with the first sample image and the sample subject, and a target ROI of the first sample image; and
generating the image segmentation model by training a preliminary image segmentation model using the plurality of training samples.

8. The system of claim 7, wherein the preliminary image segmentation model includes a first preliminary model configured to transform the sample non-image information of a sample subject into a second sample image.

9. The system of claim 8, wherein the preliminary image segmentation model further includes a second preliminary model configured to segment the first sample image of a sample subject.

10. The system of claim 9, wherein the generating the image segmentation model includes:
determining the first model by training the first preliminary model using the sample non-image information of the plurality of training samples; and
determining, based on the first model, the second model by training the second preliminary model using the first sample images and the target ROIs of the first sample images of the plurality of training samples.

11. The system of claim 9, wherein the generating the image segmentation model includes:
determining the first model and the second model simultaneously based on the first preliminary model, the second preliminary model, and the plurality of training samples.

12. The system of claim 10, wherein the generating the image segmentation model further includes:
assessing a loss function that relates to the first model and the second model.

13. The system of claim 10, wherein
the generating the image segmentation model further includes assessing a first loss function that relates to the first model.

14. The system of claim 10, wherein
the generating the image segmentation model further includes assessing a second loss function that relates to the second model.

15. The system of claim 1, wherein the image segmentation model is a machine learning model.

16. The system of claim 1, wherein the first image is a medical image including at least one of: a magnetic resonance (MR) image, a computed tomography (CT) device image, a positron emission tomography (PET) image, a single photon emission computed tomography (SPECT) image, an ultrasound image, an X-ray (XR) image, a computed tomography-magnetic resonance imaging (MRI-CT) image, a positron emission tomography-magnetic resonance imaging (PET-MRI) image, a single photon emission computed tomography-magnetic resonance imaging (SPECT-MRI) image, a digital subtraction angiography-magnetic resonance imaging (DSA-MRI) image, a positron emission tomography-computed tomography (PET-CT) image, or a single photon emission computed tomography-computed tomography (SPECT-CT) image.

17. A method for image segmentation, implemented on a computing device including at least one processor and at least one storage medium, comprising:
obtaining a first image of a subject;
obtaining non-image information associated with at least one of the first image or the subject; and
determining a region of interest (ROI) of the first image based on the first image, the non-image information, and an image segmentation model.

18. The method of claim 17, wherein the image segmentation model includes a first model configured to transform the non-image information into a second image.

19. (canceled)

20. The method of claim 18, wherein the image segmentation model further includes a second model configured to segment the first image based at least on the second image.

21-33. (canceled)

34. A system for contouring a region of interest (ROI) of a medical image, comprising:
at least one storage device including a set of instructions; and
at least one processor configured to communicate with the at least one storage device, wherein when executing the set of instructions, the at least one processor is configured to direct the system to perform operations including:
obtaining a medical image of a patient;
obtaining non-image information associated with at least one of the medical image or the patient; and
determining an ROI of the medical image based on the medical image, the non-image information, and an image segmentation model.

35-66. (canceled)
